(19) United States
(12) Patent Application Publication
(10) Pub. No.: US 2004/0023623 A1
(43) Pub. Date: Feb. 5, 2004

(54) Device for controlling, regulating and/or putting an active implant into operation

(76) Inventors: Roman Stauch, Igersheim (DE); Manfred Wittenstein, Bad Mergentheim (DE)

Correspondence Address: BACHMAN & LAPOINTE, P.C., 900 CHAPEL STREET, SUITE 1201, NEW HAVEN, CT, 06510, US

(21) Appl. No.: 10/416,196

(22) PCT Filed: Oct. 12, 2001
(86) PCT No.: PCT/EP01/11809

(30) Foreign Application Priority Data
Nov. 9, 2000 (DE) 100 55 519.5

(51) Int. Cl. H04B 1/00

(52) U.S. Cl. 455/115.1; 455/127.1; 455/128

(57) ABSTRACT

A device for controlling, regulating an/or putting an active implant, especially a distraction device, into operation which can be implanted together with a receiver and to which data and/or power can be provided from the exterior via a transmitter. The device is further characterized in that the receiver can be directly placed on the implant in such a manner that it can be detached, or it can be linked with the implant.

The present invention relates to a device for controlling, regulating and/or putting an active implant into operation, especially a distraction device, which can be implanted with a receiver unit and to which data and/or power can be supplied from the outside via a transmitter unit.

Devices of this type for controlling and/or putting an active implant into operation, especially distraction devices, are known and customary on the market in various forms and designs: They serve substantially for the distraction of any desired bones, bone parts, bone segments or else for insertion into medullary spaces of bones.

It is known in the prior art that for example an implant is adjoined by a connector which leads to a subcutaneously implantable receiver unit, which can then be contactlessly activated, for example mechanically, from the outside by means of a transmitter unit.

A disadvantage of this is that the subcutaneously implanted receiver unit disturbs the patient, and possibly causes pain, for example if it has to be implanted over a prolonged period of time.

Furthermore, a receiver unit of this type, connected by a cable, is susceptible to damage when it is being surgically inserted for example. A receiver unit of this type can only be exchanged with difficulty if it is damaged. Usually, the complete implant must be removed or exchanged, which leads to undesired costs and operating times and also risks of a renewed operation for the patient.

DE 197 00 225 A1 discloses a distraction device for moving two parts of a bone apart. In this case, an intramedullary nail is formed in two parts, an operating device which can be supplied from an induction coil via an electrical line being provided in one part of the intramedullary nail. The induction coil is subcutaneously implantable.

DE 198 56 013 A1 describes a distraction device for the surgical correction of spinal disorders and also damage or deformities. This comprises two elements which are movable with respect to each other, which transmits power to the distraction device contactlessly via a power transmission element. In this case, the power transmission element is connected to the distraction device by means of a connecting line. A similar distraction device is described in international patent application WO 00/33751. There, power is also transmitted via a power transmission element, which adjoins an actuating device via a connecting line.

The present invention is based on the object of providing a device of the type stated at the beginning which overcomes the stated disadvantages and with which a receiver unit can be exchanged very inexpensively and effectively and power and/or data transmission are to be improved considerably. Moreover, operating times are to be shortened.

It helps to achieve this object that the receiver unit can be connected to an end piece of the implant end-on in such a way that it can be detached again to establish the mechanical and electrical connection as an interface from the receiver unit to the implant.

In the case of the present invention, the receiver unit preferably adjoins an end piece of the implant in such a way that it can be detached again. This preferably takes place mechanically, in that for example a threaded peg or a threaded pin of the receiver unit engages into the implant end-on in a matching internal thread, and consequently establishes a centering action and mechanical connection. These and other possibilities for connection of a mechanical type are conceivable.

For example, plug-in latching connections may be provided, to place the receiver unit on the implant, preferably end-on, in such a way that it can be detached again.

It is important, however, that the connecting of the receiver unit to the implant, especially to the end piece of the implant, at the same time has the effect of establishing a connection for the transmission of inductive and/or electrical signals between the receiver unit and the implant. For this purpose, corresponding contacting pads may be provided on an offset of the receiver unit, which then fit into corresponding matching contact locations, contact areas or the like of the implant. The power and data transmission may also take place inductively between the receiver unit and the implant. In this case, mechanical contacts are no longer needed.

This ensures that for example an inductive power transmission and a data transmission take place to the active implant, bidirectionally as far as the data transmission is concerned, by means of a corresponding external transmitter unit which is merely placed onto the skin.

Preferably, the implant is implanted into a medullary space of the bone and subsequently, after introduction of the implant, the receiver unit is screwed into the implant after the locking of the implant with respect to the bone, which is for example to be lengthened, and establishes a mechanical interface and an electrical interface with respect to the implant on the one hand and with respect to the transmitter unit on the other hand.

In this case, the transmitter unit can transmit the power to the receiver unit in any desired position, for example laterally at right angles. However, end-on transmission of power and/or data from the transmitter unit to the receiver unit is also possible. This allows many possible applications to be realized, in particular for bone distraction, so that power and/or data can be exchanged very comfortably, without a subcutaneously disturbing separately inserted receiver unit. In this case, the transmitter unit may be placed onto the skin from the outside from a number of sides as desired. It may also be envisaged, for example, to design the transmitter unit as a cuff which can be put on, as an annular coil or in a similar annular form, to slip or place this for example over an arm or a leg in order to supply the receiver unit with power and/or data. This is likewise intended to be within the scope of the present invention.

Further advantages, features and details of the invention emerge from the following description of preferred exemplary embodiments and on the basis of the drawing, in which:

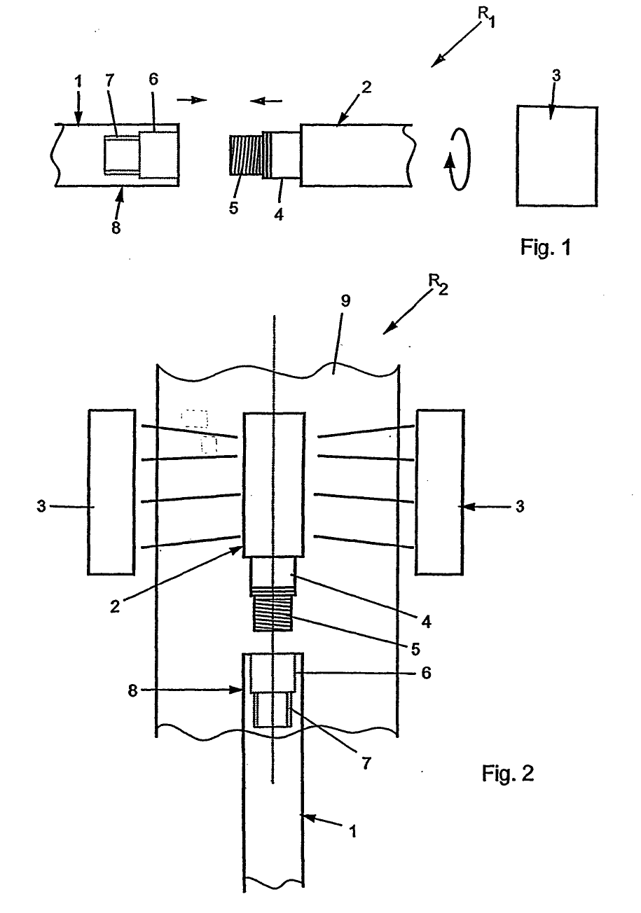

FIG. 1 shows a schematically represented plan view of a device for controlling, regulating and/or putting an active implant into operation;

FIG. 2 shows a schematically represented plan view of the device according to FIG. 1 in a different position for use.

According to FIG. 1, a device R₁ according to the invention for controlling, regulating and/or putting an active implant 1 into operation has a receiver unit 2, which can be actuated by means of a transmitter unit 3. In the preferred exemplary embodiment, the receiver unit 2 is formed in a cross-sectionally round and elongate manner and is provided at the end with an offset 4, which adjoins the receiver unit 2 end-on. In this case, the offset 4 is preferably also formed in a cross-sectionally round manner and comprises corresponding contact tracks, coil elements or the like, in order to transmit data and/or power from the receiver unit 2 to the implant 1. Adjoining the offset 4 is a thread 5, which forms an external thread. The thread 5 is preferably provided with a centering means, not represented here in any more detail, in order to center especially the offset 4 so that it fits exactly into a corresponding contact area 6 of the implant 1 and in particular to position it. Instead of the mechanical contacts, the power and/or data transmission may also take place inductively and contactlessly, also bidirectionally.

It has proven to be especially advantageous in the case of the present invention to provide an end piece 8 of the implant 1 in particular with an inner contact area 6 and adjoining internal thread 7, in order to connect the receiver unit 2 to the implant 1 end-on.

In the case of the present invention, the implant 1 is introduced into a medullary space of the respective limbs 9, for example end-on, for the distraction of bones. After inserting and anchoring the implant 1 into the medullary space 9, the receiver unit 2 is subsequently screwed onto the end piece 8 of the implant 1 end-on, whereby the electrical connections and contacts for the data and/or power transmission are at the same time established between the receiver unit 2 and the implant 1. During the implantations or operations, the interface of the contact area 6 or the internal thread 7 is protected from being damaged by instruments.

This has the advantage that the sensitive receiver unit 2 is not damaged or destroyed during the operation, in particular during the insertion of the implant 1 into the medullary space 9 of a bone.

It is also advantageous that, in particular as a result of the receiver unit 2 adjoining the implant 1 end-on, it is inserted completely with the implant 1 into the bone to be extended, without a cable connection, for example a flexible cable connection, having to be established between the implant and the receiver unit 2, lying subcutaneously uncomfortably under the skin and sustainable only under certain conditions.

It is also advantageous that the receiver unit 2 can be exchanged again at any time, if it should for example be replaced by another unit, providing different power output or different data exchange. This is likewise intended to be within the scope of the present invention.

Preferably, the receiver unit 2 is formed in a cross-sectionally round and elongate manner, but it can also assume other forms.

In FIG. 2, a the device R₂ is represented, in which the transmitter unit 3 can be placed laterally or, as represented in FIG. 1, with its end face outside the skin or onto the skin, in order to supply the receiver unit 2 correspondingly with data and/or power. This device may for example be formed flexibly or rigidly as a cuff or as a ring in one or more parts, also in such a manner that it can be divided. This allows very many areas of use to be covered, if in particular the receiver unit 2 can be actuated laterally by the transmitter unit 3 or end-on, as represented in FIG. 1.

Furthermore, it is intended to be envisaged to form a transmitter unit 3 radially and, if appropriate, coaxially in an annular form, in order to encompass the areas of the receiver 2 completely. A number of individual transmitter units 3 may also be placed radially on the outside and/or end-on onto the skin, in order to transmit power and/or data.

List of reference numerals

| | |
|---|---|
| 1 | implant |
| 2 | receiver unit |
| 3 | transmitter unit |
| 4 | offset |
| 5 | thread |
| 6 | contact area |
| 7 | internal thread |
| 8 | end piece |
| 9 | limbs/medullary |
| | space |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| R₁ | device |
| R₂ | device |

1. A device for controlling, regulating and/or putting an active implant (1) into operation, especially a distraction device, which can be implanted with a receiver unit (2) and to which data and/or power can be supplied from the outside via a transmitter unit (3), characterized in that the receiver unit (2) can be placed directly on the implant (1) in such a way that it can be detached again or can be made to adjoin the implant (1).

2. The device as claimed in claim 1, characterized in that, after inserting the implant (1) into a medullary space of a limb (9) of a bone, the receiver unit (2) can be connected to establish electrical contacts or connections for power transmission and/or data exchange, if appropriate bidirectionally.

3. The device as claimed in claim 1 or 2, characterized in that the receiver unit (2) can be connected to the implant (1) end-on in such a way that it can be detached again.

4. The device as claimed in at least one of claims 1 to 3, characterized in that the receiver unit (2) has at least one offset (4) for the internal contacting and transmission of data and/or power to the implant (1), adjoined by a thread (5), if appropriate with a centering means, or if appropriate bayonet fasteners, plug-in latching connections or the like.

5. The device as claimed in at least one of claims 1 to 4, characterized in that the implant (1) is provided at the end face with a corresponding internal thread (7) and a corresponding contact area (6) for contacts of at least one offset (4) of the receiver unit (2).

6. The device as claimed in at least one of claims 1 to 5, characterized in that the receiver unit (2) is formed in a cross-sectionally round and elongate manner.

7. The device as claimed in at least one of claims 1 to 6, characterized in that the receiver unit (2) can be connected in such a way that it can be detached again to an end piece (8) of the implant (1), in particular can be connected in such a way that it can be detached again.

8. The device as claimed in claim 7, characterized in that the receiver unit (2) can be screwed into the end piece (8) to establish the mechanical and electrical connection as an interface from the receiver unit (2) to the implant (1).

9. The device as claimed in at least one of claims 1 to 8, characterized in that the receiver unit (2) can be connected to the implant (1) in such a way that it can be exchanged and replaced at any time.

10. The device as claimed in at least one of claims 1 to 9, characterized in that power is supplied from the outside via the transmitter unit (3), in particular by means of inductive power transmission, to the receiver unit (2), which feeds the inductively coupled-in power to the implant (1) for putting a drive device into operation, especially a micromotor.

11. The device as claimed in at least one of claims 1 to 10, characterized in that the receiver unit (2) transmits data, such as telemetric data of sensor signals, path signals, force signals, to the transmitter unit (3), also bidirectionally.

12. The device as claimed in at least one of claims 1 to 11, characterized in that the transmitter unit (3) is formed in the manner of a cuff, in the manner of a circular ring, and if appropriate extends coaxially over the receiver unit (2) for the exchange of power and/or data.

13. The device as claimed in claim 12, characterized in that the transmitter unit (3) is formed flexibly or rigidly and can be placed onto the limbs (9) coaxially, laterally or end-on from the outside.

14. The device as claimed in at least one of claims 1 to 13, characterized in that a power transmission and/or a data exchange take place inductively between the receiver unit (2) and the implant (1), if appropriate also bidirectionally.
